(19) United States
(12) Patent Application Publication
(10) Pub. No.: US 2014/0330571 A1
(43) Pub. Date: Nov. 6, 2014

(54) The personalized Genome report

(71) Applicant: Jeffrey Charles Lester, Ellicott City, MD (US)

(72) Inventor: Jeffrey Charles Lester, Ellicott City, MD (US)

(21) Appl. No.: 13/694,100

(22) Filed: May 3, 2013

(51) Int. Cl. G06Q 50/22; G06Q 10/00

(52) U.S. Cl. CPC G06Q 50/22; G06Q 10/00
USPC 705/2

(57) ABSTRACT

The Personalized Genome Report (The PGR) is a unique business process that is a paper based method for reporting whole genome sequencing. The PGR is specifically designed for primary care-doctors/physicians to use risk values for diseases and genetic characteristics from the patient's genome to form a wellness plan with the patient to help the patient stay healthy as they age. The PGR is designed to have no mention of specific genetic alleles or mutations or cumbersome statistics to potentially confuse patients. Only information that pertains specifically to a patient's disease risk is contained in the PGR. The PGR also discusses environmental and drug allergies and Mendelian disorders and information on the mitochondrial genome. It is designed to be a comprehensive look at the patient's genetic risk.

This document explains the design of the PGR and some of the thinking that went into decisions for the PGR.

The Personalized Genome Report is a business process—a paper only product that explains in concise terms the information that physicians and patients would need from the patient's whole genome sequence to formulate a health and wellness plan moving forward in the patient's life. It is low-tech solution to a physician sitting down with a patient and discussing a plan to keep the patient safe and healthy as they age.

The company I formed after creating the PGR I named Genomefire. The website address is: www.genomefire.com

I created the PGR because I saw a large hole in the current way sequencing companies explain their data to physicians and patients. Being a physician who has training in both Medical Genetics and Internal Medicine, I understand what primary care doctors want and don't want in ordering tests. A great part of testing is making sure the physician clearly understands the results and is able to make decisions efficiently. —That the primary care physician be given enough clear information that he/she has the ability to act in conjunction with the patient in their best interest. At present, sequencing and interpretation companies are relying on computer software to explain the genetic information as it pertains to disease risk to doctors and patients. As far as I have seen, the physicians are provided with online-software data on hundreds or thousands of mutations and genetic variants covering over 100 different diseases. With busy practices, physicians do not have the time to review the salient points of the patient's genome with booting up a computer and trying to navigate software they or the patient may be unfamiliar with. The average patient has a high school education and may have little or no understanding of basic concepts in genetics or statistics. The present state of affairs in personalized medicine using whole genome sequencing is not well suited to use by the majority of physicians or patients. This was the impetus for my creating the PGR.

The PGR was created by me alone using my own personal experiences in working with patients and with what I know of medical genetics and business, having studied all of these in university or medical training in the past. I created a rough draft of the PGR in the summer and fall of 2011 which looked very close in structure and length to what the final product is. For the record, after I created a prototype I contacted a former academic colleague of mine, Dr. Klaas Wierenga who currently is a medical geneticist at the University of Oklahoma. On the phone I told him what I had created and I wanted him to take a look at it to proof read it and give me any suggestions or thoughts he might have. I explained that I was going to start a company and submit the PGR for a US Patent. He said he was busy with a big exam his students were taking but would get back me soon. After a week or two went by I wanted to get his attention so I mailed to his home a check for $200—as reimbursement for his time. We phoned and emailed and texted several times for a couple months around summer/fall 2011. When he was less busy I had him sign a non-disclosure agreement and once he faxed the NDA back to me I emailed him the prototype of the PGR. He looked it over and made several corrections and a few suggestions and emailed all of this back to me. After some conversations back and forth I got a new idea of adding the discussion about an intake form and the ICD-9 codes on the PGR. Dr. Wierenga is the only person I asked to help me after I created the prototype of the PGR. At most he spent a few hours helping me—via long distance in Oklahoma. Most of his contributions were in the form of exposing typographical errors and some comments on the diseases I chose as examples. Dr. Wierenga never cashed the $200 check I sent him. He said he was helping me with the PGR as a friend. He never asked me for any form of compensation even though I was clear I was starting a company and filing the PGR as a patent.

The PGR is designed as a reporting tool only and does not consider how the raw data was interpreted or even if the interpretation or statistical methods are accurate. —This would be the responsibility of the genetic testing company or the interpretation company.

Whole genome sequencing has been sold for clinical use in patients since about 2010 or so. Certainly most WGS reporting has thus far been for research purposes and for cancer research/treatment. There are a handful of companies that have sequenced genomes and given out/sold data via software in the clinical market. The industry has been moving slowly, unsure of itself.

My position is that over the next several decades, whole genome sequencing will radically change the lives of billions of people. This starts by sequencing millions of genomes and that won't happen until patients by and large understand that sequencing their genome can help them lead healthier safer lives. Physicians need a very easy and very fast way of understanding a patient's whole genome sequence report. Patients need a product they can hold in their hands and read over and over and think about and discuss with their families. A product they can keep in a filing cabinet and go back to when needed. This is what I have done with the Personalized Genome Report.

Certainly, there are a very large number of data points and decisions that have to be made in telling a physician or a patient what a patient's absolute risk is for a specified disease with a specified ICD-9 code. The PGR assumes there is a genius team of bioinformaticists and PhDs and statisticians and computer-software programmers that have already setup a sophisticated set of computer algorithms where every ICD-9 code (for a disease) and every drug allergy and every environmental allergen that is mentioned in the patient's PGR has its own file—its own data set and algorithms as to how exactly the data sets line up and how the absolute risk values on the PGR are arrived at. What set of decisions and medical/scientific research articles are used for each disease? What weight value is given to each data point? How much of the patient's environmental factors is calculated into the absolute risk values? What does the team know about the patient's environment? How confident are they in what they understand of the patient's environment in making decisions regarding formulating an absolute risk value number with understanding of the patient's genome and genetic variants and mutations? Obviously as the patient ages their environment may change—sometimes radically, all of this can have great impact on their genetic coding and what the absolute risk values are. All of this collection of data/private patient information and dissemination of patient risk to the physician and the patient will be a constant process over the course of most patients' lives.

Every Part of the PGR is specifically designed to give the patient enough information to explain the purpose of each section but at the same time to avoid giving the patient or doctor information which might overload the clinic visit or was not actionable. —Looking at the first page, you will notice that every page has a page number in the upper right hand corner. The total number of pages for the report is also listed. This is to avoid confusion for the doctor and patient so all parties involved know when they have the complete report in their hands and that no pages are missing. Each page of the report has the full name of the patient, the date of the report and the page numbers. This will ensure reports from different patients will never get mixed up or placed out of order. For the patient, having the report date is also important since many patients may have these reports in their homes and when they get their genomes re-analyzed, conceivably, some patients will have several PGRs in their files. The report date at the top of every page ensures the patient will not get reports done at different times mixed together. Each report in itself has a specific health and wellness plan attached to it agreed upon by the physician-patient partnership.

I specifically did not put a place for the patient's social security number. Indeed, I believe that the SSN is quite overused and having it on this type of report will put at risk the patient's personal information and would unnecessarily increase the risk of identity theft. For this reason I specifically included other identifiers such as the city, state and country that appears on the patient's birth certificate and the patient's race. The inclusion of the race/ethnicity identifier was deliberate also because these terms are confusing to some people. I expect that ordering a whole genome sequencing test will entail filling out a patient intake form. Such a sheet would do very well to have the patient's ICD-9 codes and drug allergies listed as well as a pertinent family history of disease as this information will create powerful data sets when analyzed appropriately with large numbers of genomes. —Also the patient order sheet might have many boxes (similar to those on a US census sheet) for patients to check off which race or ethnicity they most identify with. —In genetics, Jewish people have higher risks for certain Mendelian disorders versus the general population. This is because many Jewish people tend to marry and have children with other Jewish people descended mostly from the Hassidic or Sephardic Jews going back hundreds of years and the recessive alleles have hung around due to this selection bias. So there is confusion among some people regarding what constitutes race versus ethnicity. In part 2 of the PGR I listed the patient's genetic racial makeup based on the analysis performed by the testing company. Obviously there are genetic differences among the races and some races as a group carry higher risks for certain diseases. I asked the patient to identify themselves by race/ethnicity on the first page as a patient identifier but also to help the patient understand that their race as determined by the PGR has genetic and disease implications that they should remain aware of. I also wanted people to understand from the PGR that most of us are a combination of many different groups of people.

It is important to note something I have omitted on purpose in the PGR. There is no company logo anywhere or phone number or company address/email listed. Each company who licenses the PGR can put on the PGR a company logo or company identifier as stipulated in future contracts/licenses.

The Legal Disclaimer is something I had thought about for a long time in regards to someday designing the PGR. I have never much been a fan of legal disclaimers with pages and pages of stuff that hardly ever pertains to the person reading it. Well, in the PGR the information is very personal and may define how someone lives their lives and thinks about themselves. There were very specific things I wanted to make the sure the patient understood in holding the report. In 2011 we are still in the early days of genome interpretation and while a few companies are forging ahead, it is critical that the patient understand that some of the risk calculations will change over time as millions of genomes get added to the pool. I wanted the patient to understand that they must revisit this information periodically to have the best data with which to make healthcare decisions. As a scientist and as a physician, it is my sincere hope that sequencing companies will share the anonymized medical/family histories and genomic data they obtain with other companies. Such sharing will be a great multiplier in understanding disease and saving lives. The sequencing companies will have a great deal to learn from each other in the logistics and assumptions they make in their programming and algorithms. The more sharing of ideas that occurs the more robust the data will be, the more robust the risk values will be and this will add to the confidence of the system.

It is obvious to me that the PGR can be part of a larger online interface system in communicating health information to patients and doctors. A lot of software designing and thought has yet to occur to have an ideal system where patients and doctors can readily access information that has clear significance. My problem with what I have seen so far has always been “well, what does the patient or doctor do with all this data”. In genetics sometimes we are guilty of information overload and I took great pains to make sure that wasn't a problem in the PGR.

In the Legal Disclaimer, I mentioned a Patient Handout. No doubt there will also be a Primary Care Doctor handout as well as online tutorials. These are designed by the companies to give some background explanation to patients and doctors. They should give enough background to explain the importance of the information and how it is obtained but avoid over-explaining concepts or terms the patient may not find useful. The handout should also explain with examples how a person's environment can affect their risk of disease. The information provided to the physicians will explain more complex terms and concepts and illustrate how a physician might take the information as a whole and form a wellness plan for the patient.

Sections of the PGR are separated by a thick black line to provide a clear visual cue to the patient that one part has ended and another part has begun and that each part should be taken and understood by itself.

A brief explanation of Mendelian Genetics is provided in Part 3 which provides information on Carrier Status. This to me was important, because, taken by itself the PGR can give enough information for the patient to have a reasonable understanding of what the document is trying to explain. It is understood that the patient may have read the Patient Handout days or weeks before seeing their PGR and their memory of important concepts may have eroded. Some patients may not have even read the Patient Handout, but if they carefully read the PGR and listen to their doctor there is a high chance they will be able to understand the important parts of the report. With the development of each section independently—the PGR can act as a stand-alone product.

In Part 3 it was important that the patient understand that they should compare their list to that of their partner if they plan to have children. The patient needed to understand that the information was taken from mutations found in various patients who were previously documented with the disease and that if their carrier status were positive for a certain disease the information would not change. I also wanted the patient to understand that no one is genetically perfect and they should expect to find a fair number of carrier mutations in their genome.

After much thought I included Part 4 to provide a very powerful tool for the sequencing companies to use a patient's medical history and drug allergy history when looking at their genetic makeup. In theory, with a near perfect understanding of the genome, the bioinformatics should predict what patients are at high risk for and what they are likely to be diagnosed with. Though in reality, accurately interpreting complex diseases is still in its infancy—we are still crawling and won't begin walking until hundreds of thousands of genomes are sequenced and compared side by side along with medical histories. I feel very strongly that a medical history via ICD-9 codes should accompany each patient's genome sample. This would be done with the intake form which I believe should be required to be filled out before a patient genetic sample is accepted for analysis. ICD-9 codes are well established for virtually all diseases and are very easy to code into databases. Physicians are very comfortable using ICD-9 codes and the bioinformaticists/genetic testing companies need to get comfortable using them. —To truly be able to predict complex gene disorders it is important for the bioinformatics team to know if a patient has a cholesterol of 286 or weighs 380 pounds or is 6 feet 11 inches tall or is thin and has very high blood pressure or very difficult to control type 2 diabetes mellitus or has had three heart attacks with a normal cholesterol level and normal blood pressure by the time they are 45 or required kidney dialysis in their 30's or has a long history of severe depression with suicide attempts or has severe schizophrenia, etc. I believe that in time it will become obvious to the various testing companies—once the technology has more time to mature, that they will not be able to give their best risk values without the patient's medical and drug allergy history. To this point, also, they would do well in improving their data sets to have an understanding of the patient's environment.

In Part 5, discussing complex gene disorders, I wanted to provide a brief explanation on absolute risk and to differentiate it from other types of risk such as relative risk or attributed risk. —Part 5 is the central focus of the PGR. I was very careful in giving the patient just enough information for them to understand how they compare to the general population and what they should most worry about. I wanted to avoid throwing a bunch of risk values and numbers and mutations at the patient—knowing that with each new variable the patient had to remember, their overall understanding of the big picture might suffer. I think this is where some of the software profiles used today go wrong. The diseases listed are only as an example.

I specifically focused on explaining absolute risk because it is the most useful. The third column of Part 5 shows the relative risk but I specifically did not introduce this second concept because again, this would lead to confusion in some patients. —It was enough for them to understand how many more or less times likely their risk was for the disease versus the general public.

I had some consternation about whether I should have provided a different tier of risk for the more common disorders. —If something is very common like breast cancer—might some women want to know if their risk is 15% instead of 11% which is the lifetime female population risk? It is true that for more common diseases, there is generally increased surveillance—as in mammography and PSA testing or vision screens, etc. —I was concerned that (in relation to the PGR) stratifying more common diseases with a stricter cut off for relative risk in the third column would confuse the patient.

Again, I wanted to avoid giving the patient dozens of SNPs or mutations to look at when seeing their risks for complex disorders. I was afraid this would provide more confusion to most patients. If the patient or physician wish to delve deeper into the data they are always able to take the extra time and contact the testing company directly or access their information online.

The last part of the PGR mentions the Mitochondrial Genome. The patient needs to understand that the mitochondrial genome is completely separate from the nuclear genome and why it exists. I did not explain how proteins in mitochondria are derived from both genomes or the specifics of mitochondrial inheritance because these points are not critical for the patient to understand that a defect in the Mitochondrial genome can cause disease.

As a physician, knowing that patients taking the time to read and understand a Patient Handout as a separate document from the PGR might be sporadic at best, I tried to make the PGR a stand-alone product as much as possible- something that someone could look at many, many times and have a clear understanding of all the information presented.

With tens of millions of patients and primary care doctors seeing 20+ patients per day, I do not see any realistic way that whole genome sequencing will become consistently used in mainstream medical practice without the use of something very similar to the PGR.

1. The Personlized Genome Report (the PGR) is a business process I created that puts the information for a patient's genome into a paper format that the doctor can hold in his/her hand and tell the patient what their genetic risks are for many different diseases. It is the first comprehensive genetic report, using information from a patient's DNA, RNA, methylation and protein structures, on paper to give the patient risk information on the major areas of disease and illness. The PGR gives the physician the ability with using a paper format to quickly and specifically tell the patient what their risks are for single gene disorders and complex gene disorders/common diseases. The PGR also contains information on what medication allergies and environmental allergies the patient has and disease information on the mitochondrial genome. Absolute risk and relative risk values are included in the PGR. There is no information regarding specific gene mutations or gene variants on the PGR. The PGR is specifically designed to avoid confusion and only give the doctor and patient information regarding risk of disease. The common diseases are listed with ICD-9 codes which are the disease codes that doctors use with charting and billing insurances. In the future in the PGR we will use ICD-10 codes, ICD-11 and so forth to use same coding the doctors will use for billing purposes.
